(19) United States
(12) Patent Application Publication
(10) Pub. No.: US 2025/0128378 A1
(43) Pub. Date: Apr. 24, 2025

(54) DISPLAY DEVICE, NUMERICAL CONTROL DEVICE, MACHINING SYSTEM, DISPLAY METHOD, NUMERICAL CONTROL METHOD, AND MACHINING METHOD

(71) Applicant: Mitsubishi Electric Corporation, Tokyo (JP)

(72) Inventors: Hiroki KANEKO, Tokyo (JP); Go SATO, Tokyo (JP)

(73) Assignee: Mitsubishi Electric Corporation, Tokyo (JP)

(21) Appl. No.: 18/725,931

(22) PCT Filed: Jan. 6, 2022
(86) PCT No.: PCT/JP2022/000266

§ 371 Date: Jul. 1, 2024

(51) Int. Cl. B23Q 15/12

(52) U.S. Cl. CPC B23Q 15/12; G05B 2219/45038

(57) ABSTRACT

A display device includes: a cutting point information acquisition unit acquiring cutting point information indicating a position of a cutting point at which a tool attached to a machine tool cuts a workpiece, the cutting point corresponding to each of a plurality of tip points included in a tool trajectory that is information indicating a movement path of the tip point of the tool; a feature acquisition unit acquiring a feature indicating a characteristic of machining, the feature being calculated corresponding to each of the tip points based on operational information that is information indicating an operational status of the machine tool, the tool trajectory, and the cutting point information; and a display unit displaying each of a plurality of the cutting points using an expression method indicating the feature corresponding to the cutting point based on the cutting point information and the feature.

### FIELD

The present disclosure relates to a display device, a numerical control device, a machining system, a display method, a numerical control method, and a machining method for supporting analysis work of machining with a machine tool.

### BACKGROUND

In order to machine a workpiece with a machine tool that is numerically controlled, a machining program describing a movement command for moving the workpiece of a tool is used. Generally, machining programs are created by computer-aided design (CAD)/computer-aided manufacturing (CAM) systems. The created machining program is input to a numerical control device that controls a machine tool, and the numerical control device analyzes the machining program and creates a command position of each drive shaft by interpolating the tool path obtained from the movement command for each predetermined control cycle. The numerical control device changes the relative position between the tool and the workpiece by controlling each drive shaft of the machine tool based on the command position. As a result, cutting is performed in which the tool cuts the workpiece.

At this time, a machining defect may occur, such as a machining flaw on the machining surface of the workpiece or a shape error of the workpiece. In order to obtain a desired machining surface, the worker needs to identify the cause of the machining defect and take a necessary step to prevent the occurrence of the machining defect. In order to identify the cause, analysis that considers various factors related to machining is required, which is a difficult work for the worker.

Patent Literature 1 discloses a display device that obtains the tip point of a tool from a command position and a detected position in every control cycle with respect to a drive shaft of the machine tool, and displays the acceleration or jerk of the tip point on the trajectory of the tip point based on a preselected display format. According to this display device, the acceleration or the jerk, which is information on the movement of the tool, is displayed on the trajectory of the tip point indicating the movement of the tool, which can support the analysis work in which the worker identifies the cause of a machining defect.

### CITATION LIST

### Patent Literature

Patent Literature 1: Japanese Patent No. 5192574

### SUMMARY OF INVENTION

### Problem to be Solved by the Invention

However, in many cases, the shape of the machining surface of the workpiece and the shape of the trajectory of the tip point of the tool do not match. For example, in the case of performing simultaneous five-axis machining in which straight axes and rotation axes of a machine tool move simultaneously, or in the case of performing machining using a tool having a special shape such as a tool including an outer peripheral blade on the tool side surface or a barrel tool, the positions of the cutting points at which the tool actually cuts the machining surface are not uniform but are greatly shifted with respect to the position of the tip point. In this case, the shape of the machining surface of the workpiece and the shape of the trajectory of the tip point of the tool may greatly differ. In such a case, with the technique disclosed in Patent Literature 1, it is necessary for the worker to find the correspondence relationship between a machining defect on the machining surface of the workpiece and information displayed on the trajectory of the tip point in order to identify the cause of the machining defect, which is problematic in that labor for the analysis work of identifying the cause of the machining defect generated in machining with the machine tool increases.

The present disclosure has been made in view of the above, and an object thereof is to obtain a display device capable of reducing labor for the analysis work of identifying the cause of a machining defect generated in machining with a machine tool.

### Means to Solve the Problem

In order to solve the above-described problems and achieve the object, a display device according to the present disclosure includes: a cutting point information acquisition unit to acquire cutting point information indicating a position of a cutting point that is a point at which a tool attached to a machine tool cuts a workpiece, the cutting point corresponding to each of a plurality of tip points included in a tool trajectory that is information indicating a movement path of the tip point of the tool; a feature acquisition unit to acquire a feature indicating a characteristic of machining, the feature being calculated corresponding to each of the plurality of tip points based on operational information that is information indicating an operational status of the machine tool, the tool trajectory, and the cutting point information; and a display unit to display each of a plurality of the cutting points using an expression method indicating the feature corresponding to the cutting point based on the cutting point information and the feature.

### Effects of the Invention

The present disclosure can achieve the effect of reducing labor for the analysis work of identifying the cause of a machining defect generated in machining with a machine tool.

### BRIEF DESCRIPTION OF DRAWINGS

FIG. 1 is a diagram illustrating a functional configuration of a display device according to the first embodiment.

FIG. 2 is a diagram illustrating an example of a tool that is based on the tool information stored in the tool information storage unit illustrated in FIG. 1.

FIG. 3 is a perspective view illustrating an example of a machining target shape stored in the machining target shape storage unit illustrated in FIG. 1.

FIG. 4 is a side view of the machining target shape illustrated in FIG. 3.

FIG. 5 is a top view of the machining target shape illustrated in FIG. 3,

FIG. 6 is a perspective view illustrating an example of a tool trajectory generated by the tool trajectory calculation unit illustrated in FIG. 1.

FIG. 7 is a top view illustrating an example of the tool trajectory generated by the tool trajectory calculation unit illustrated in FIG. 1.

FIG. 8 is a diagram for explaining the arrangement of the tool and the machining curved surface.

FIG. 9 is a diagram for explaining the relationship between the tip point of the tool and the cutting point.

FIG. 10 is a diagram for explaining the cutting point of the tool which is away from the machining curved surface,

FIG. 11 is a diagram for explaining the cutting point of the tool which interferes with the machining curved surface,

FIG. 12 is a diagram illustrating cutting points calculated corresponding to the tip points illustrated in FIG. 8.

FIG. 13 is a first diagram for explaining a method of obtaining the tip point adjacent to an arbitrary tip point included in the tool trajectory.

FIG. 14 is a second diagram for explaining a method of obtaining the tip point adjacent to an arbitrary tip point included in the tool trajectory.

FIG. 15 is a third diagram for explaining a method of obtaining the tip point adjacent to an arbitrary tip point included in the tool trajectory.

FIG. 16 is a diagram illustrating an example of a screen on which the display unit illustrated in FIG. 1 displays a cutting point group superimposed on a perspective view of the machining target shape.

FIG. 17 is a diagram illustrating an example of a screen on which the display unit illustrated in FIG. 1 displays the cutting point group superimposed on a top view of the machining target shape.

FIG. 18 is a diagram illustrating an example of a screen on which the display unit illustrated in FIG. 1 displays a top view of the machining target shape using the display color calculated according to the feature,

FIG. 19 is a diagram illustrating an example of a screen on which the display unit illustrated in FIG. 1 displays only the cutting point group on the machining curved surface designated by the curved surface designation unit on a perspective view of the machining target shape.

FIG. 20 is a diagram illustrating an example of a screen on which the display unit illustrated in FIG. 1 displays only the cutting point group on the machining curved surface designated by the curved surface designation unit on a top view of the machining target shape.

FIG. 21 is a flowchart for explaining the operation of the display device illustrated in FIG. 1.

FIG. 22 is a diagram illustrating an exemplary configuration of a computer system that implements the display device according to the first embodiment.

FIG. 23 is a diagram illustrating a functional configuration of a modification of the first embodiment.

FIG. 24 is a flowchart for explaining the operation of the display device illustrated in FIG. 23.

FIG. 25 is a diagram illustrating a functional configuration of a display device according to the second embodiment.

FIG. 26 is a diagram for explaining a method with which the feature calculation unit illustrated in FIG. 25 obtains the corresponding tip point,

FIG. 27 is a diagram illustrating a functional configuration of the numerical control device according to the third embodiment.

FIG. 28 is a flowchart for explaining the operation of the numerical control device illustrated in FIG. 27.

FIG. 29 is a diagram illustrating dedicated hardware for implementing the functions of the numerical control device according to the third embodiment.

FIG. 30 is a diagram illustrating a configuration of the control circuit for implementing the functions of the numerical control device according to the third embodiment.

### DESCRIPTION OF EMBODIMENTS

Hereinafter, a display device, a numerical control device, a machining system, a display method, a numerical control method, and a machining method according to embodiments of the present disclosure will be described in detail with reference to the drawings.

### First Embodiment

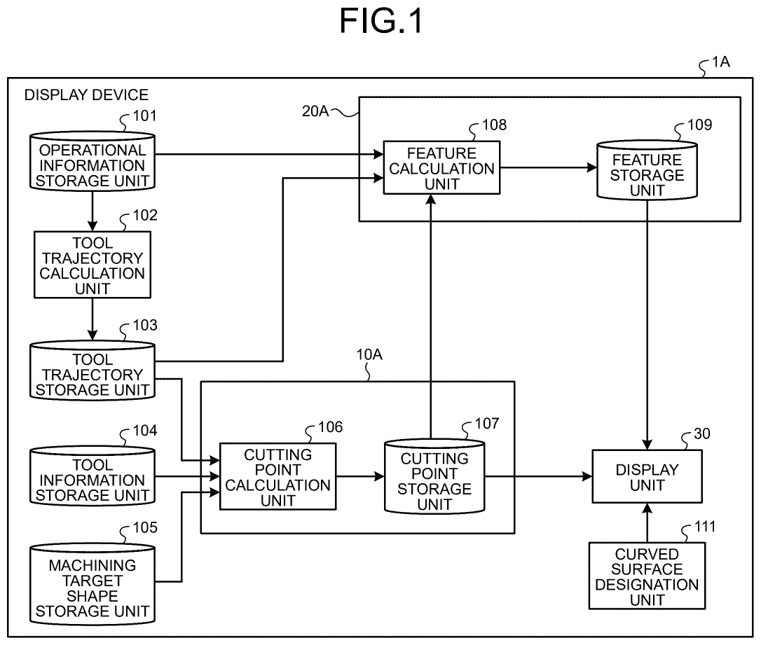

FIG. 1 is a diagram illustrating a functional configuration of a display device 1A according to the first embodiment. The display device 1A includes an operational information storage unit 101, a tool trajectory calculation unit 102, a tool trajectory storage unit 103, a tool information storage unit 104, a machining target shape storage unit 105, a cutting point information acquisition unit 10A including a cutting point calculation unit 106 and a cutting point storage unit 107, a feature acquisition unit 20A including a feature calculation unit 108 and a feature storage unit 109, a display unit 30, and a curved surface designation unit 111.

The display device 1A has a function of displaying information about machining performed by a machine tool 4 (not illustrated in FIG. 1) under the control of a numerical control device 3 (not illustrated in FIG. 1), thereby supporting the analysis work of identifying the cause of a machining defect generated in machining performed by the machine tool 4.

First, an example of data that is used by the display device 1A will be described with reference to the drawings.

The operational information storage unit 101 stores operational information, which is information indicating the operational status of the machine tool 4 in which the machine tool 4 is operated. The operational information includes information obtained from the machine tool 4, the numerical control device 3 that controls the machine tool 4, a sensor attached to the machine tool 4, or the like. More specifically, the operational information can include, for example, position data of each of a plurality of drive shafts included in the machine tool 4, the load and current value of the spindle of the machine tool 4, the internal temperature of the machine tool 4, the machining program and machining conditions that are used for operation of the machine tool 4, and state data such as parameters of the numerical control device 3. The position data, the load of the spindle, current value, and the internal temperature of the machine tool 4 are time-series data synchronized by time. The position data of the drive shaft is information generated by the numerical control device 3, and includes at least one of a command position in every predetermined control cycle with respect to each of the plurality of drive shafts of the machine tool 4 or a detected position detected in every control cycle from the position detector of each of the plurality of drive shafts. The operational information may be information acquired by actually operating the machine tool 4, or may be information generated by simulating the operations of the numerical control device 3 and the machine tool 4 through simulation or the like.

The tool information storage unit 104 stores tool information that is information defining the shape of a tool for machining a workpiece. The tool information includes information from which a tool shape can be generated, for example, information such as tool type, tool diameter, and tool length. In the case of a rotary tool such as an end mill, the tool information may include the tool central axis and the outer contour of the tool. In the case of an asymmetric shape such as a turning tool, the tool information may include parameter information.

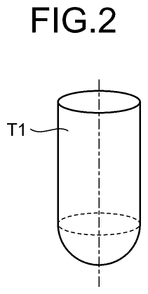

FIG. 2 is a diagram illustrating an example of a tool T1 that is based on the tool information stored in the tool information storage unit 104 illustrated in FIG. 1, The tool T1 illustrated in FIG. 2 is a ball end mill which is an end mill having a spherical tip.

The machining target shape storage unit 105 stores shape information indicating a machining target shape, which is target shape of the workpiece. The machining target shape includes a machining curved surface, which is curved surface to be machined with the tool T1.

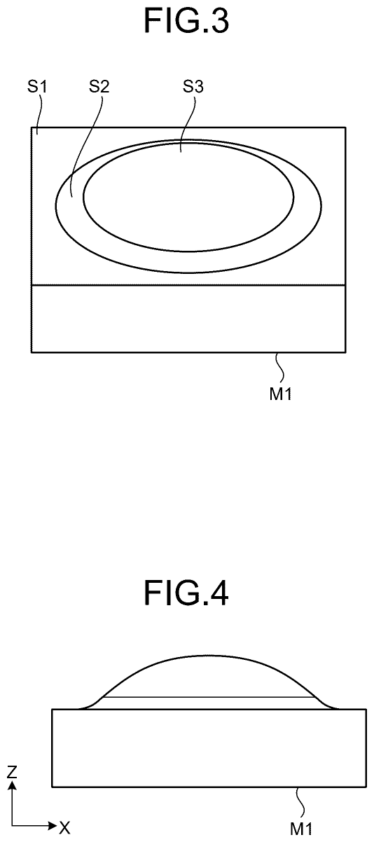

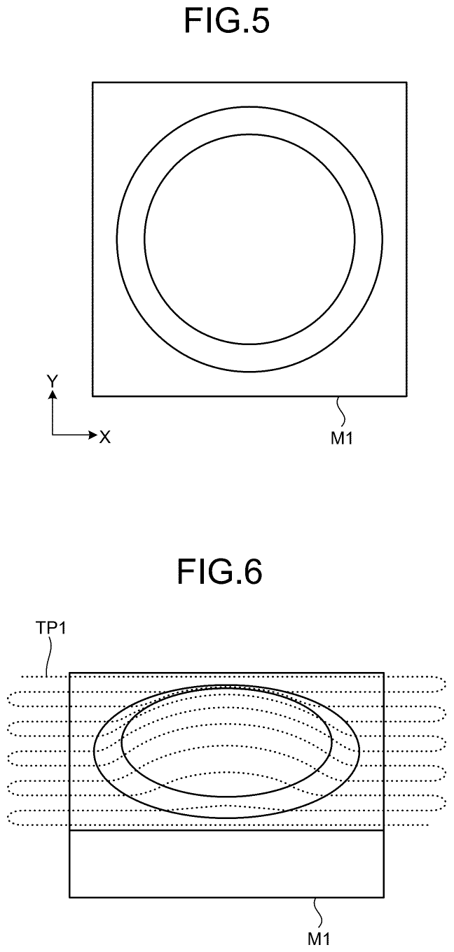

FIG. 3 is a perspective view illustrating an example of a machining target shape M1 stored in the machining target shape storage unit 105 illustrated in FIG. 1. FIG. 4 is a side view of the machining target shape M1 illustrated in FIG. 3. FIG. 5 is a top view of the machining target shape M1 illustrated in FIG. 3. The machining target shape M1 includes machining curved surfaces S1 to S3. The machining curved surfaces S1 to S3 may be simply referred to as the machining curved surface S when it is not necessary to distinguish therebetween.

The operational information, tool information, and shape information described above are acquired from the outside of the display device 1A. The operational information, the tool information, and the machining target shape M1 may be read from the information stored in a storage medium outside the display device 1A, may be acquired via a communication path, or may be information input by a worker using an input means such as a keyboard. The shape information may be information generated by performing data conversion from CAD data, or may be information generated by a worker inputting a figure through keyboard operation.

The tool trajectory calculation unit 102 generates a tool trajectory, which is trajectory of the tip point of the tool, based on the operational information stored in the operational information storage unit 101, and stores the generated tool trajectory in the tool trajectory storage unit 103. Here, the tool trajectory calculation unit 102 performs coordinate transformation on the position data of the time-series data included in the operational information to obtain the position of the tip point of the tool and the tool direction at the position. The position data may be a command position or a detected position, Which position data is to be used may be determined in advance or may be selected by the worker. Here, the tool trajectory calculation unit 102 performs coordinate transformation of the position data using the relative relationship between information included in the parameters of the numerical control device 3, such as the configuration of the drive shaft of the machine tool 4, the tool length, and the coordinate system, and the coordinate system of the machining target shape. As to the relative relationship between the coordinate system included in the parameters of the numerical control device 3 and the coordinate system of the machining target shape, for example, an offset amount may be stored in advance or may be designated by a worker. The position of the tip point obtained in this manner is associated with each piece of time-series data and also stored as a tool trajectory.

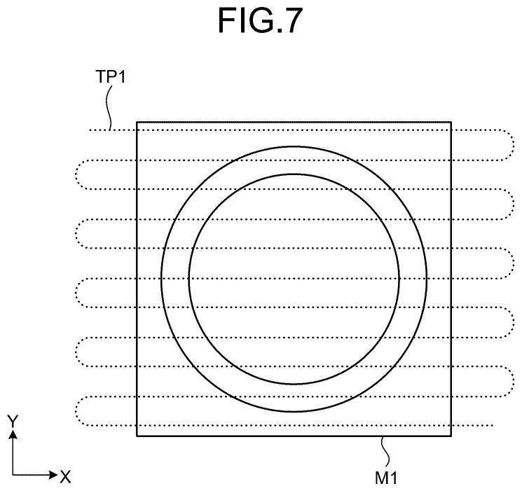

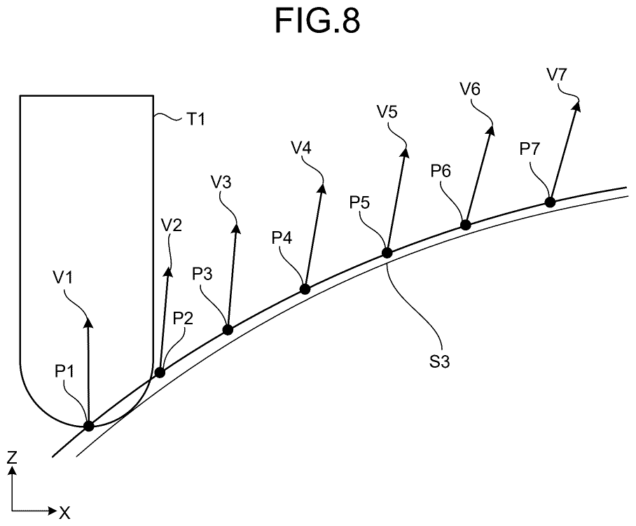

FIG. 6 is a perspective view illustrating an example of a tool trajectory TP1 generated by the tool trajectory calculation unit 102 illustrated in FIG. 1, FIG. 7 is a top view illustrating an example of the tool trajectory TP1 generated by the tool trajectory calculation unit 102 illustrated in FIG. 1. FIGS. 6 and 7 illustrate the tool trajectory TP1 and the machining target shape M1. FIG. 8 is a diagram for explaining the arrangement of the tool T1 and the machining curved surface S. FIG. 8 illustrates the positions of tip points P1 to P7 included in the tool trajectory TP1 and tool directions V1 to V7 in which the tool is located at the tip points P1 to P7, respectively. FIG. 8 is a cross-section illustrating how the tool T1 passes on the machining curved surface S3 of the machining target shape M1. At this time, the arrangement relationship between the tool T1 and the machining curved surface S3 is determined according to the positions of the tip points P1 to P7 and the tool directions V1 to V7 at the positions. Hereinafter, the tip points P1 to P7 may be simply referred to as the tip point P when it is not necessary to distinguish therebetween, and the tool directions V1 to V7 may be simply referred to as the tool direction V when it is not necessary to distinguish therebetween.

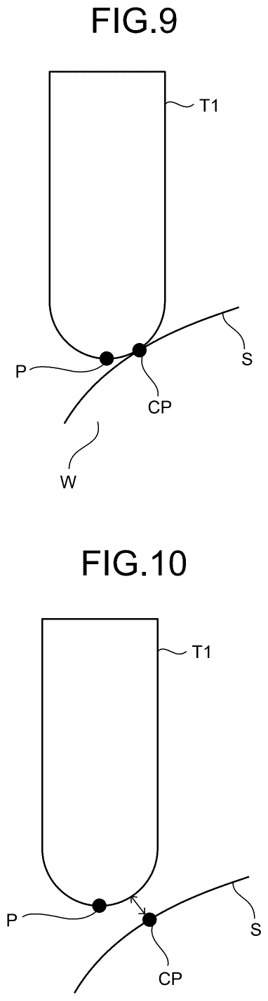

The cutting point calculation unit 106 of the cutting point information acquisition unit 10A calculates the position of the cutting point, which is the point at which the tool T1 attached to the machine tool 4 cuts the workpiece W, based on the tool trajectory TP1 stored in the tool trajectory storage unit 103, the tool information stored in the tool information storage unit 104, and the machining target shape M1 stored in the machining target shape storage unit 105. Here, the cutting point will be described, FIG. 9 is a diagram for explaining the relationship between the tip point P of the tool T1 and the cutting point CP. The tip point P is a point located at the tip of the tool T1, and the position thereof on the tool T1 does not change. The cutting point CP is a point at which the tool T1 cuts the workpiece W, and is ideally a point at which the tool T1 contacts the machining curved surface S of the workpiece W. FIG. 9 illustrates the cutting point CP in contact with the machining curved surface S.

The cutting point calculation unit 106 calculates the position of the cutting point CP corresponding to each of the plurality of tip points P included in the tool trajectory TP1. Specifically, for each of the plurality of tip points P included in the tool trajectory TP1, the cutting point calculation unit 106 calculates the cutting point CP of the tool T1 with respect to the machining curved surface S, which is on the machining curved surface S of the machining target shape M1 based on the position of the tip point P and the tool direction V. Because the position of the tip point P and the tool direction V are a relative position and a relative direction with respect to the machining target shape M1, a relative positional relationship between the tool T1 and the machining curved surface S of the machining target shape M1 is determined according to the position of the tip point P and the tool direction V, and this positional relationship is ideally a state in which the tool T1 and the machining curved surface S are in contact with each other. Therefore, when the tool T1 and the machining curved surface S are in contact with each other as illustrated in FIG. 9, the cutting point calculation unit 106 obtains, as the cutting point CP, a point at which the tool T1 and the machining curved surface S are in contact with each other on the machining curved surface S.

However, in practice, an error is included in the position of the tip point P of the tool and the tool direction V, and thus the tool T1 and the machining curved surface S may not be in contact with each other. For example, there may be a case where the tool T1 disposed according to the position of the tip point P calculated based on the operational information is away from the machining curved surface S. FIG. 10 is a diagram for explaining the cutting point CP of the tool T1 which is away from the machining curved surface S. When the tool T1 is away from the machining curved surface S as illustrated in FIG. 10, the cutting point calculation unit 106 can obtain one point on the machining curved surface S at which the distance between the tool T1 and the machining curved surface S is the shortest, and set this point as the cutting point CP.

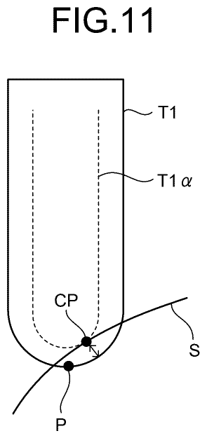

In addition, there may be a case where the tool T1 disposed according to the position of the tip point P calculated based on the operational information interferes with the machining curved surface S. FIG. 11 is a diagram for explaining the cutting point CP of the tool T1 which interferes with the machining curved surface S. When the tool T1 interferes with the machining curved surface S as illustrated in FIG. 11, assuming that the tool T1 offset to come into contact with the machining curved surface S is an offset tool T1α, the cutting point calculation unit 106 can obtain a point at which the offset tool T1α and the machining curved surface S are in contact with each other, and set this point as the cutting point CP. Although an example in which the tool T1 is a ball end mill is illustrated here, the cutting point CP can be calculated with a similar method even for the tool T1 that has a special shape such as a radius end mill, a flat end mill, a barrel tool, or a turning tool.

The cutting point calculation unit 106 stores, in the cutting point storage unit 107, cutting point information in which the positions of the plurality of cutting points CP obtained with the above-described method are associated with the corresponding tip points P. Depending on the relationship between the tool T1 and the machining curved surface S, a plurality of cutting points CP may be calculated for one tip point P. In this case, the plurality of cutting points CP may be stored in association with the one tip point P.

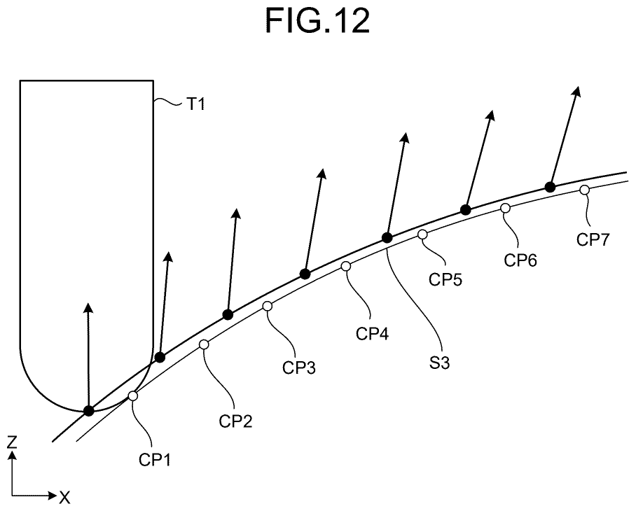

FIG. 12 is a diagram illustrating cutting points CP1 to CP7 calculated corresponding to the tip points P1 to P7 illustrated in FIG. 8, respectively. Although reference signs are omitted in FIG. 12 for the sake of simplicity, black circles (namely, filled-circle symbols) illustrated in FIG. 12 are the tip points P1 to P7 illustrated in FIG. 8, and arrows illustrated in FIG. 12 are the tool directions V1 to V7 illustrated in FIG. 8. FIG. 12 illustrates the cutting points CP1 to CP7 of the tool T1 with respect to the machining curved surface S3 when the tool T1 moves on the machining curved surface S3 of the machining target shape M1 according to the plurality of tip points P1 to P7 and the tool directions V1 to V7 included in the tool trajectory TP1. The cutting points CP1 to CP7 respectively corresponding to the tip points P1 to P7 are calculated.

The feature calculation unit 108 of the feature acquisition unit 20A calculates a feature of machining corresponding to each of the plurality of tip points P included in the tool trajectory TP1 based on the operational information stored in the operational information storage unit 101, the tool trajectory TP1 stored in the tool trajectory storage unit 103, and the cutting point information stored in the cutting point storage unit 107. The feature calculation unit 108 stores the calculated feature in the feature storage unit 109 in association with the cutting point CP. The feature calculation unit 108 may directly associate the feature with the cutting point CP, or associate the feature with the tip point P to regard the features associated with a common tip point P as the features corresponding to the cutting point CP.

The feature is an amount representing a characteristic of machining. The feature includes, for example, at least one of machining error amount that is a distance between the machining target shape M1 and the tool T1 disposed according to the position of the tip point P, speed of the tip point P, acceleration of the tip point P, jerk of the tip point P, speed of the cutting point CP, acceleration of the cutting point CP, jerk of the cutting point CP, position of each of the plurality of drive shafts of the machine tool 4, speed of each of the plurality of drive shafts of the machine tool 4, acceleration of each of the plurality of drive shafts of the machine tool 4, jerk of each of the plurality of drive shafts of the machine tool 4, or reverse position of each of the plurality of drive shafts of the machine tool 4.

Here, the machining error amount can be calculated as the shortest distance between the position of the cutting point CP corresponding to the tip point P of the tool T1 and the shape surface of the tool T1 disposed according to the position of the tip point P and the tool direction V.

The speed, acceleration, and jerk of the tip point P of the tool T1 can be calculated as follows, Given that the position of the tip point P at a certain time t is PT(t), and the position of the tip point P at time t+Δt advanced from time t by the time period corresponding to a predetermined control cycle is PT(t+Δt), the speed VT(t) of the tip point P at time t is obtained by dividing the distance between the positions of the two tip points P by the time period corresponding to the predetermined control cycle, and is expressed by Formula (1) below.

$$\begin{matrix}Formula 1 & \\ VT ( t ) = \frac{PT ( t + Δ t ) - PT ( t )}{Δ t} & ( 1 )\end{matrix}$$

The acceleration AT(t) of the tip point P at time t is expressed by Formula (2),

$$\begin{matrix}Formula 2 & \\ AT ( t ) = \frac{VT ( t + Δ t ) - VT ( t )}{Δ t} & ( 2 )\end{matrix}$$

The jerk JT(t) of the tip point P at time t is expressed by Formula (3).

$$\begin{matrix}Formula 3 & \\ JT ( t ) = \frac{AT ( t + Δ t ) - AT ( t )}{Δ t} & ( 3 )\end{matrix}$$

The speed, acceleration, and jerk of the cutting point CP can be calculated as follows. Given that the position of the cutting point CP corresponding to the tip point P at a certain time t is PC(t), and the position of the cutting point CP corresponding to the tip point P at time t+Δt advanced from t by the time period corresponding to a predetermined control cycle is PC(t+Δt), the speed VC(t) of the cutting point CP corresponding to the tip point P at time t is expressed by Formula (4) below.

$$\begin{matrix}Formula 4 & \\ VC ( t ) = \frac{PC ( t + Δ t ) - PC ( t )}{Δ t} & ( 4 )\end{matrix}$$

In addition, the acceleration AC(t) of the cutting point CP corresponding to the tip point P at time t is expressed by Formula (5).

$$\begin{matrix}Formula 5 & \\ A C ( t ) = \frac{VC ( t + Δ t ) - VC ( t )}{Δ t} & ( 5 )\end{matrix}$$

In addition, the jerk JC(t) of the cutting point CP corresponding to the tip point P at time t is expressed by Formula (6).

$$\begin{matrix}Formula 6 & \\ JC ( t ) = \frac{A C ( t + Δ t ) - A C ( t )}{Δ t} & ( 6 )\end{matrix}$$

The position, speed, acceleration, and jerk of each of the plurality of drive shafts of the machine tool 4 can be calculated as follows. The position PM1(t) of a first drive shaft corresponding to the tip point P at a certain time t can be acquired from the time-series data of the operational information.

Given that the position of the first drive shaft corresponding to the tip point P at time t+Δt advanced from time t by the time period corresponding to a predetermined control cycle is PM1(t+Δt), the speed VM1(t) of the first drive shaft corresponding to the tip point P at time t is expressed by Formula (7) below.

$$\begin{matrix}Formula 7 & \\ VM 1 ( t ) = \frac{PM 1 ( t + Δ t ) - PM 1 ( t )}{Δ t} & ( 7 )\end{matrix}$$

In addition, the acceleration AMI(t) of the first drive shaft corresponding to the tip point P at time t is expressed by Formula (8).

$$\begin{matrix}Formula 8 & \\ AM 1 ( t ) = \frac{VM 1 ( t + Δ t ) - VM 1 ( t )}{Δ t} & ( 8 )\end{matrix}$$

In addition, the jerk JMl(t) of the first drive shaft corresponding to the tip point P at time t is expressed by Formula (9).

$$\begin{matrix}Formula 9 & \\ JM 1 ( t ) = \frac{AM 1 ( t + Δ t ) - AM 1 ( t )}{Δ t} & ( 9 )\end{matrix}$$

The position, speed, acceleration, and jerk of any other drive shaft than the first drive shaft can be calculated with a similar method.

The reverse position of each of the plurality of drive shafts of the machine tool 4 can be calculated as follows. With the above-described method, the speed VM1(t) of the first drive shaft corresponding to the tip point P at a certain time t and the speed VM1(t+Δt) of the first drive shaft corresponding to the tip point P at time t+Δt advanced from time t by the time period corresponding to a predetermined control cycle are calculated. At this time, the sign of the speed VM1(t) is compared with the sign of the speed VM(t+Δt), and the position corresponding to the time when the sign is inverted can be set as the reverse position of the first drive shaft. The reverse position of any other drive shaft than the first drive shaft can be obtained with a similar method.

Furthermore, the feature calculation unit 108 can also use a difference in feature between two adjacent tip points P as the feature. At this time, the two adjacent tip points P are a set of two tip points P having the shortest distance on two adjacent tool trajectories. For example, in a CAD/CAM system, for a tool trajectory of what is called scanning line machining or contour line machining generated in parallel on a plane and at a constant pitch, or for a tool trajectory of what is called along-surface machining generated at a constant pitch based on the contour of the machining curved surface S of the machining target shape M1, two adjacent tip points P are obtained by selecting the closest tip point P on an adjacent tool trajectory passing through a position separated by the pitch with respect to a certain tip point P.

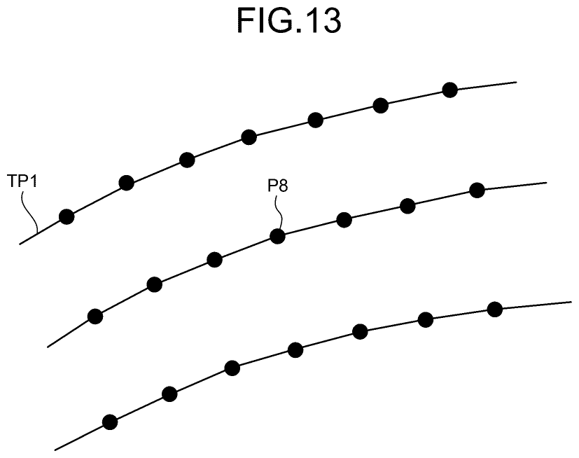

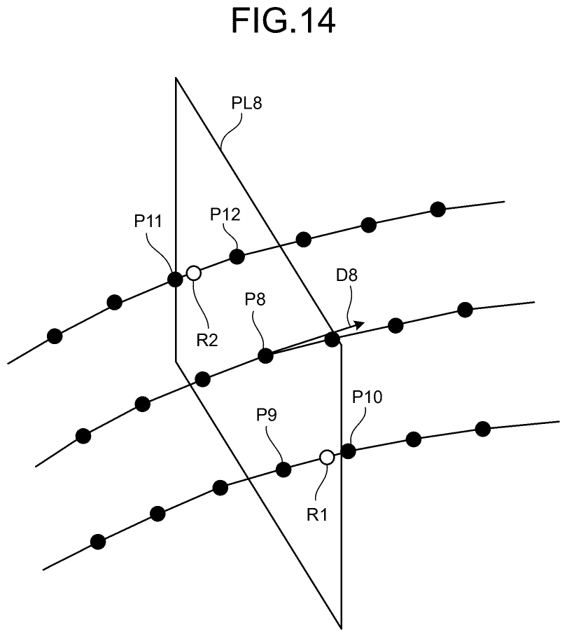

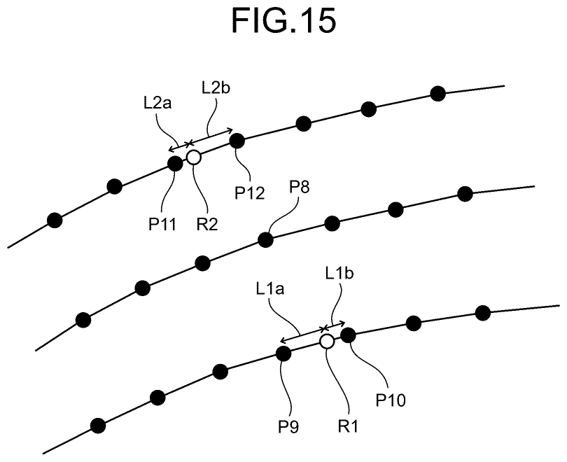

Here, a method of obtaining the tip point P adjacent to an arbitrary tip point P included in the tool trajectory TP1 will be described with reference to FIGS. 13 to 15. FIG. 13 is a first diagram for explaining a method of obtaining the tip point P adjacent to an arbitrary tip point P included in the tool trajectory TP1, FIG. 14 is a second diagram for explaining a method of obtaining the tip point P adjacent to an arbitrary tip point P included in the tool trajectory TP1. FIG. 15 is a third diagram for explaining a method of obtaining the tip point P adjacent to an arbitrary tip point P included in the tool trajectory TP1. FIG. 13 illustrates the tip point P8 included in the tool trajectory TP1 and a part of the tool trajectory around the tip point P8. Consider a case where the tip point P adjacent to the tip point P8 is obtained. As illustrated in FIG. 14, first, assume a plane PL8 having a traveling direction D8 at the tip point P8 as a normal vector. Here, the traveling direction D8 may be obtained from the relationship between the tip point P8 and the front and rear tip points P, or may be a direction which is separately predetermined. Next, the feature calculation unit 108 obtains an intersection point between the assumed plane PL8 and the tool trajectory. At this time, an intersection point R1 located between the tip points P9 and P10 and an intersection point R2 located between the tip points P11 and P12 are obtained.

Next, as illustrated in FIG. 15, the feature calculation unit 108 obtains a distance Lla between the intersection point R1 and the tip point P9 and a distance Lib between the intersection point R1 and the tip point P10, By comparing the distances Lla and Llb, the feature calculation unit 108 sets the tip point P10 having a shorter distance from the intersection point R1 among the tip points P9 and P10 as a candidate for the adjacent tip point P. Similarly, the feature calculation unit 108 obtains a distance L2a between the intersection point R2 and the tip point P11 and a distance L2b between the intersection point R2 and the tip point P12. By comparing the distances 12a and 12b, the feature calculation unit 108 sets the tip point P11 having a shorter distance from the intersection point R2 among the tip points P11 and P12 as a candidate for the adjacent tip point P. The feature calculation unit 108 may select, from among the plurality of candidate tip points P10 and P11 obtained here, one having a shorter distance from the tip point P8 or one present in a specific direction with respect to the traveling direction D8. Here, suppose that the tip point P11 adjacent to the tip point P8 is selected. In this case, the feature calculation unit 108 can set a difference in feature, which is value obtained by subtracting the feature of the tip point P11 from the feature of the tip point P8, as a new feature of the tip point P8.

Note that the features described in detail above are examples, and the feature calculation unit 108 can calculate physical information such as the load and current value of the spindle of the machine tool 4 and the internal temperature of the machine tool 4 for each of the tip points P and store the physical information in the feature storage unit 109. In addition, the feature calculation unit 108 may calculate one type of feature or may simultaneously calculate and store two or more types of features.

Based on the cutting point information acquired by the cutting point information acquisition unit 10A and the feature acquired by the feature acquisition unit 20A, the display unit 30 displays each of the plurality of cutting points CP included in the cutting point information using an expression method indicating the feature corresponding to the cutting point CP. At this time, the display unit 30 can display the cutting point CP superimposed on the machining target shape M1. There is no limitation on the expression method for use in indicating the feature corresponding to the cutting point CP, For example, near the symbol indicating the position of the cutting point CP, a numerical value indicating the corresponding feature may be displayed, or the feature may be indicated using the display color, display shape, display form, or the like of the symbol indicating the position of the cutting point CP. Some examples will be described below.

For example, when the feature is a real value, the display unit 30 obtains the maximum value and the minimum value of the feature in advance, and assigns display colors to the maximum value and the minimum value. Then, the display unit 30 determines the display color of each of the cutting points CP by interpolating the two display colors assigned to the maximum value and the minimum value according to the magnitude of the feature. By displaying the cutting points CP using the determined display color, the display unit 30 displays the cutting points CP using the expression method indicating the feature corresponding to the cutting points CP, so that the cutting points CP can be distinguished according to the feature. Alternatively, the display unit 30 may determine the display density of each of the cutting points CP by assigning display densities to the maximum value and the minimum value and interpolating the two display densities assigned to the maximum value and the minimum value according to the magnitude of the feature, and display the cutting points CP using the determined display density. At this time, the display unit 30 may allow the worker to select what kind of display color or display density is used for display. For example, the display density may be the density of the color to be displayed.

In addition, when the feature is a value classified into a plurality of classifications, the display symbol representing the cutting point CP can be determined in advance for each classification. In this case, the display unit 30 can identify the assigned display symbol according to the feature corresponding to each of the cutting points CP, and display the cutting points CP using the identified display symbol. The worker may be allowed to select what kind of display symbol is assigned.

Furthermore, when the feature is a binary value represented by zero or one, for example, by determining the feature of zero as an invisible state and the feature of one as a visible state, each of the cutting points CP can be individually displayed either in the invisible state or the visible state according to the feature. Note that the feature of zero may be set as the visible state and the feature of one may be set as the invisible state. The worker may be allowed to select which is set as the visible state or the invisible state.

Note that, if a plurality of features are calculated for each of the tip points P, the display unit 30 may allow the worker to select which feature is indicated by the expression method to display the cutting point CP.

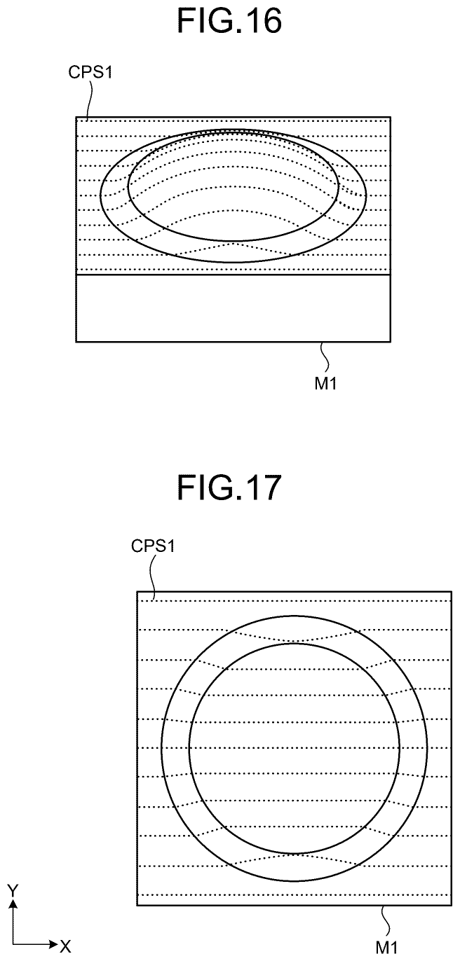

FIG. 16 is a diagram illustrating an example of a Screen on which the display unit 30 illustrated in FIG. 1 displays a cutting point group CPS1 superimposed on a perspective view of the machining target shape M1. The cutting point group CPS1 is a set of cutting points CP obtained for the tip points P included in a tool path TP1, FIG. 17 is a diagram illustrating an example of a screen on which the display unit 30 illustrated in FIG. 1 displays the cutting point group CPS1 superimposed on a top view of the machining target shape M1. FIGS. 16 and 17 illustrate an example of expressing the magnitude of the feature by changing the shading of the display color of the cutting point CP.

Here, a method of changing the shading of the display color of the cutting point CP according to the feature only needs to involve, for example, obtaining the maximum value and the minimum value of the feature in advance, determining the density of the display color of the maximum value of the feature and the density of the display color of the minimum value of the feature, and changing the display color using the density of the display color obtained through interpolation between the maximum value and the minimum value. When the display color is changed, any of the attributes of the display color such as hue, saturation, and brightness may be changed. Only one attribute may be changed, or a plurality of attributes may be changed simultaneously. In addition, for example, a plurality of types of color maps indicating display colors to be used between the minimum value and the maximum value of the feature may be prepared in advance, and the worker may be allowed to select the minimum value and the maximum value of the feature and the color map to be used. Further, for example, in the case of using the method of changing the symbol representing the cutting point CP according to the feature, the worker may be allowed to designate a symbol for displaying the cutting point CP for each feature.

If the feature acquisition unit 20A acquires a plurality of features, the display unit 30 may display a first diagram and a second diagram side by side on one screen or superimposed on one screen, the first diagram showing each of the plurality of cutting points CP using an expression method indicating a first feature that is one of the plurality of features, the second diagram showing each of the plurality of cutting points CP using an expression method indicating a second feature that is a feature different from the first feature. At this time, the display unit 30 may translucently display the cutting points CP in the first diagram or the second diagram. The worker may be allowed to select whether to display the first diagram and the second diagram side by side or superimposed on one screen.

In addition, the display unit 30 can change the color of the machining curved surface S by determining the display color of the cutting points CP based on the feature corresponding to each of the plurality of cutting points CP, and determining the display color of the machining curved surface S of the machining target shape M1 based on the display color of each of the cutting points CP on the machining curved surface S.

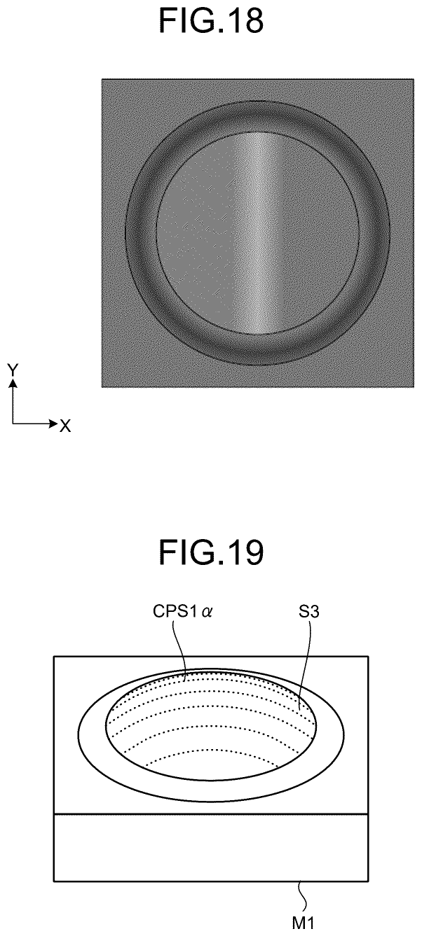

FIG. 18 is a diagram illustrating an example of a screen on which the display unit 30 illustrated in FIG. 1 displays a top view of the machining target shape M1 using the display color calculated according to the feature. The display unit 30 can calculate the display color of the cutting points CP according to the feature corresponding to each of the cutting points CP, and associate the display color of the machining curved surfaces S1 to S3 at a position where the cutting point CP does not exist on the machining curved surfaces S1 to S3 with the display color interpolated based on the display color of the surrounding cutting points CP, thereby determining the display color of each position on the machining curved surfaces S1 to S3.

The curved surface designation unit 111 designates at least one machining curved surface S included in the machining target shape M1 according to the worker operation, for example, and outputs the designated machining curved surface S to the display unit 30. For example, the curved surface designation unit 111 can display each of the machining curved surfaces S1 to S3 included in the machining target shape M1 in a selectable state, receive an input from the worker, and output the machining curved surface S selected by the worker to the display unit 30. When outputting the machining curved surface S designated by the curved surface designation unit 111, the display unit 30 displays only the cutting points CP located on the designated machining curved surface S and does not display the cutting points CP on the machining curved surface S that is undesignated.

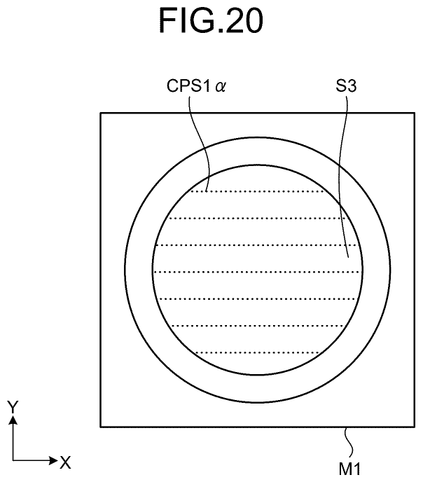

FIG. 19 is a diagram illustrating an example of a screen on which the display unit 30 illustrated in FIG. 1 displays only the cutting point group CPS1α on the machining curved surface S3 designated by the curved surface designation unit 111 on a perspective view of the machining target shape M1. FIG. 20 is a diagram illustrating an example of a screen on which the display unit 30 illustrated in FIG. 1 displays only the cutting point group CPS1α on the machining curved surface S3 designated by the curved surface designation unit 111 on a top view of the machining target shape M1. As illustrated in FIGS. 19 and 20, when the machining curved surface S3 is designated by the curved surface designation unit 111 among the machining curved surfaces S1 to S3 of the machining target shape M1, the display unit 30 displays only the cutting point group CPS1α, which is a collection of cutting points CP located on the machining curved surface S3, and does not display the plurality of cutting points CP located on the machining curved surfaces S1 and S2. In this case, information can be narrowed down to display a portion that the worker wants to focus on. Each of the cutting points CP included in the cutting point group CPS1α displayed here can also be displayed by the display unit 30 using an expression method indicating the corresponding feature.

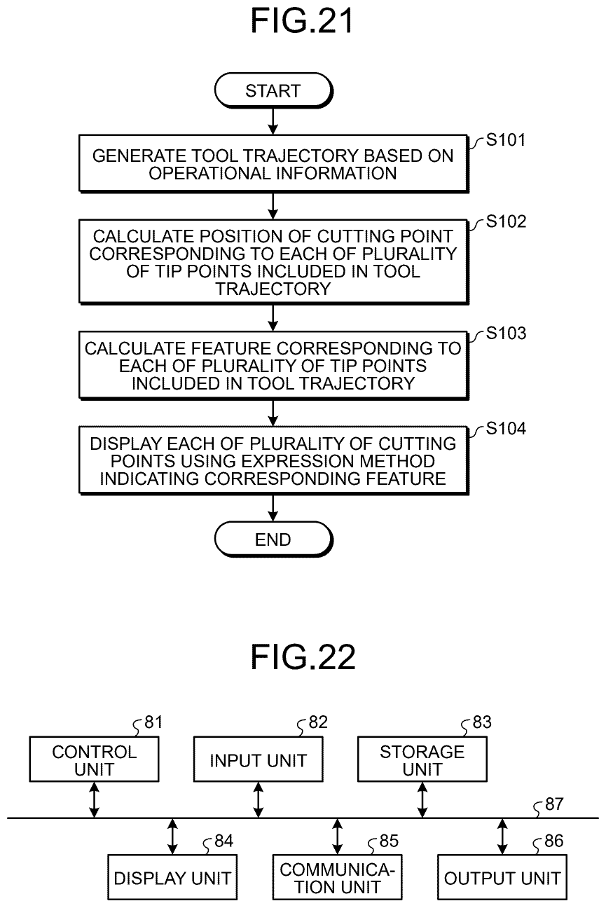

FIG. 21 is a flowchart for explaining the operation of the display device 1A illustrated in FIG. 1. First, the tool trajectory calculation unit 102 of the display device 1A generates the tool trajectory TP1 by calculating the position of the tip point P of the tool T1 based on the operational information (step S101).

Next, the cutting point calculation unit 106 calculates the position of the cutting point CP corresponding to each of the plurality of tip points P included in the tool trajectory TP1 (step S102). In addition, the feature calculation unit 108 calculates a feature corresponding to each of the plurality of tip points P included in the tool trajectory TP1 (step S103). The display unit 30 displays each of the plurality of cutting points CP using an expression method indicating the corresponding feature (step S104). Details of each step illustrated in FIG. 21 are as described above,

FIG. 22 is a diagram illustrating an exemplary configuration of a computer system that implements the display device 1A according to the first embodiment. As illustrated in FIG. 22, this computer system includes a control unit 81, an input unit 82, a storage unit 83, a display unit 84, a communication unit 85, and an output unit 86, which are connected via a system bus 87.

In FIG. 22, the control unit 81 is, for example, a central processing unit (CPU) or the like. The control unit 81 executes an analysis support program describing each process that is performed by the display device 1A according to the present embodiment. The input unit 82 includes, for example, a touch sensor, a keyboard, a mouse, and the like, and is used by the user of the computer system to input various types of information. In the above embodiment, reception of worker input indicated by phrases like “allowing the worker to select” can be performed using the input unit 82. The storage unit 83 includes various types of memories such as a random access memory (RAM) and a read only memory (ROM) and a storage device such as a hard disk. The storage unit 83 stores, for example, programs to be executed by the control unit 81 and necessary data obtained during processing. The storage unit 83 is also used as a temporary storage area for programs. The display unit 84 includes a liquid crystal display (LCD) panel or the like, and displays various screens to the user of the computer system. The communication unit 85 is a communication circuit or the like that performs communication processing. The communication unit 85 may include a plurality of communication circuits corresponding one-to-one to a plurality of communication schemes. The output unit 86 is an output interface that outputs data to an external device such as a printer or an external storage device.

Note that FIG. 22 is an example, and the configuration of the computer system is not limited to the example in FIG. 22. For example, the computer system need not include the output unit 86. Also, in a case where the display device 1A is implemented by a plurality of computer systems, not all of these computer systems need to be the computer system illustrated in FIG. 22. For example, some computer systems need not include at least one of the display unit 84, the output unit 86, and the input unit 82 illustrated in FIG. 22.

Here, an example of the operation of the computer system that is performed until the analysis support program describing the processes of the display device 1A according to the present embodiment becomes executable will be described. In the computer system having the above-mentioned configuration, for example, the analysis support program describing the operation of the display device 1A is installed on the storage unit 83 from a compact disc (CD)-ROM or digital versatile disc (DVD)-ROM set in a CD-ROM drive or DVD-ROM drive (not illustrated). Then, when the analysis support program is executed, the analysis support program read from the storage unit 83 is stored in the area of the main storage device in the storage unit 83. In this state, the control unit 81 executes the processes as the display device 1A according to the present embodiment in accordance with the analysis support program stored in the storage unit 83.

In the above description, the program describing the processes in the display device 1A is provided using a CD-ROM or DVD-ROM as a recording medium. Alternatively, the program may be provided by a transmission medium such as the Internet via the communication unit 85 according to the configuration of the computer system, the capacity of the program, and the like.

The analysis support program according to the present embodiment causes a computer to execute: a step of acquiring cutting point information indicating the position of the cutting point CP with respect to the machining target shape M1, the cutting point CP corresponding to each of a plurality of tip points P included in a tool trajectory; a step of acquiring a feature indicating a characteristic of machining, the feature being calculated corresponding to each of the plurality of tip points P based on operational information, the tool trajectory, and the cutting point information; and a step of displaying each of a plurality of cutting points CP using an expression method indicating the feature corresponding to the cutting point CP based on the cutting point information and the feature.

The operational information storage unit 101, the tool trajectory storage unit 103, the tool information storage unit 104, the machining target shape storage unit 105, the cutting point storage unit 107, and the feature storage unit 109 illustrated in FIG. 1 are a part of the storage unit 83 illustrated in FIG. 22. Each of the tool trajectory calculation unit 102, the cutting point calculation unit 106, the curved surface designation unit 111, and the display unit 30 illustrated in FIG. 1 is implemented by using the control unit 81, the input unit 82, the storage unit 83, and the display unit 84.

Note that the division of the functions in the display device 1A illustrated in FIG. 1 is an example, and the manner of dividing the functional units is not limited to the example illustrated in FIG. 1 as long as the display device 1A can perform the above-described operation. In FIG. 1, the display device 1A performs all the operations, but a plurality of devices may be used to implement similar functions. For example, in FIG. 1, the display device 1A also has the function of generating information for use in display. However, as described below as a modification, a device having the display function and a device having the function of calculating the cutting point CP and the feature may be separately provided.

### <Modification>

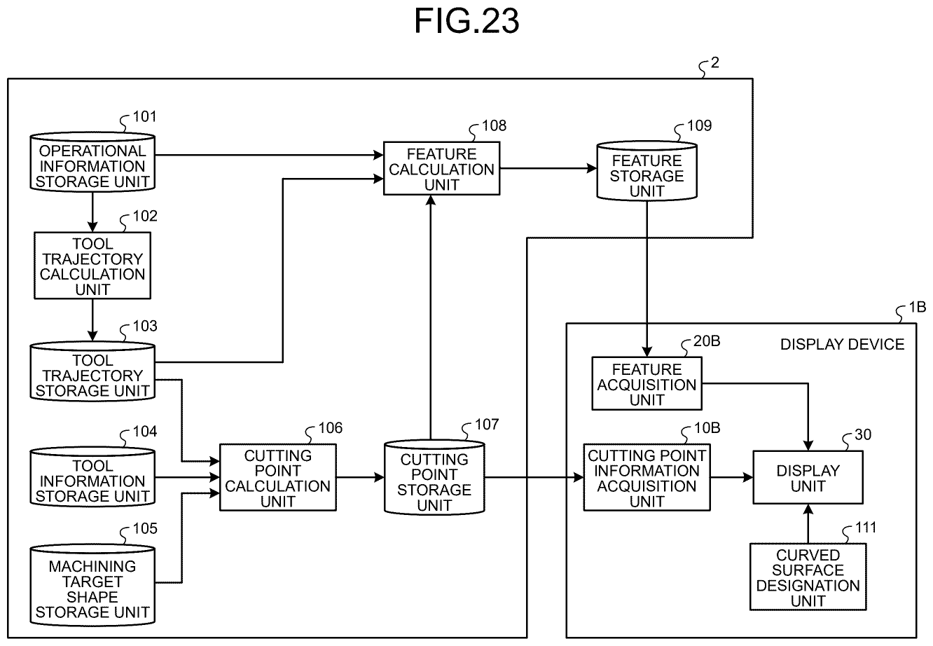

FIG. 23 is a diagram illustrating a functional configuration of a modification of the first embodiment. In the modification, a display device 1B includes a cutting point information acquisition unit 10B, a feature acquisition unit 20B, the display unit 30, and the curved surface designation unit 111. An information processing device 2 includes the operational information storage unit 101, the tool trajectory calculation unit 102, the tool trajectory storage unit 103, the tool information storage unit 104, the machining target shape storage unit 105, the cutting point calculation unit 106, the cutting point storage unit 107, the feature calculation unit 108, and the feature storage unit 109. The information processing device 2 is a device, such as a server, different from the display device 1B.

Whereas the cutting point information acquisition unit 10A of the display device 1A includes the cutting point calculation unit 106 and the cutting point storage unit 107 and has the function of generating cutting point information, the cutting point information acquisition unit 10B of the display device 1B acquires cutting point information from the information processing device 2. Also, whereas the feature acquisition unit 20A of the display device 1A includes the feature calculation unit 108 and the feature storage unit 109 and has the function of calculating the feature, the feature acquisition unit 20B of the display device 1B acquires the feature from the information processing device 2. Other functional units, which are denoted by the same reference signs as those in FIG. 1, have functions similar to those of the display device 1A, and thus a detailed description thereof will be omitted.

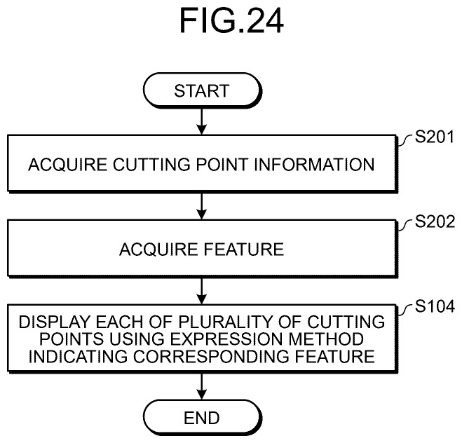

FIG. 24 is a flowchart for explaining the operation of the display device 1B illustrated in FIG. 23. The cutting point information acquisition unit 10B of the display device 1B acquires cutting point information from the information processing device 2 (step S201). Next, the feature acquisition unit 20B acquires the feature from the information processing device 2 (step S202). The display unit 30 displays each of the plurality of cutting points CP using an expression method indicating the corresponding feature (step S104).

Similarly to the display device 1A, the display device 1B and the information processing device 2 can also be implemented by using one or more computer systems illustrated in FIG. 22. In this case, each of the cutting point information acquisition unit 10B and the feature acquisition unit 20B can be implemented using the communication unit 85. In addition, the functions of the information processing device 2 may be implemented by a cloud system. In the cloud system, it is possible to freely set division of the hardware of the computer system and devices such as a server for each function. For example, one computer system may have a function as a plurality of devices, or a plurality of computer systems may have a function as one device.

As described above, the display device 1A or 1B according to the first embodiment includes: the cutting point information acquisition unit 10A or 10B that acquires cutting point information indicating the position of the cutting point CP with respect to the machining target shape M1 of the workpiece W, the cutting point CP being a point at which the tool T1 attached to the machine tool 4 cuts the workpiece W, the cutting point CP corresponding to each of a plurality of tip points P included in the tool trajectory TP1 that is information indicating a movement path of the tip point P of the tool T1; the feature acquisition unit 20A or 20B that acquires a feature indicating a characteristic of machining, the feature being calculated corresponding to each of the plurality of tip points P based on operational information that is information indicating an operational status of the machine tool 4, the tool trajectory TP1, and the cutting point information; and the display unit 30 that displays each of a plurality of cutting points CP using an expression method indicating the feature corresponding to the cutting point CP based on the cutting point information and the feature. Thus, the cutting point CP is displayed on the machining curved surface S of the machining target shape M1 using an expression method indicating the feature corresponding to the cutting point CP, which makes it easier for the worker who operates the display device 1A or 1B to find the correspondence relationship between an actual machining defect on the machining curved surface S and the feature, and makes it possible to reduce labor for the analysis work in which the worker identifies the cause of the machining defect. Therefore, the efficiency of the analysis work can be improved.

The feature acquisition unit 20A or 20B acquires, as the feature, at least one of machining error amount that is a difference between the machining target shape M1 of the workpiece W and the tool T1, speed of the tip point P, acceleration of the tip point P, jerk of the tip point P, speed of the cutting point CP, acceleration of the cutting point CP, jerk of the cutting point CP, position of a drive shaft of the machine tool 4, speed of the drive shaft, acceleration of the drive shaft, jerk of the drive shaft, and reverse position of the drive shaft. Thus, it is possible to indicate the physical information as described above on the machining curved surface S of the machining target shape M1, which makes it easier to find the correspondence relationship between the machining curved surface S having a machining defect and specific physical information, and makes it possible to further reduce the worker's labor for the analysis work.

In addition, the feature acquisition unit 20A or 20B can acquire, as the feature, a difference value of the feature between two adjacent tip points P. Therefore, when the cause of a machining defect appears in the difference in feature between adjacent tip points P, the worker's labor for the analysis work can be further reduced.

In addition, the feature acquisition unit 20A or 20B can acquire a plurality of features, and the display unit 30 can display a first diagram and a second diagram side by side on one screen or superimposed on one screen, the first diagram showing each of the plurality of cutting points CP using an expression method indicating a first feature that is one of the plurality of features, the second diagram showing each of the plurality of cutting points CP using an expression method indicating a second feature that is a feature different from the first feature. Therefore, it is possible to indicate a plurality of features on one screen, which makes it easier to grasp the correlation between the plurality of features. Thus, the worker's labor for the analysis work can be further reduced.

In addition, the display unit 30 can determine the display color of the cutting points CP based on the feature corresponding to each of the plurality of cutting points CP, and determine the display color of the machining curved surface S of the machining target shape M1 based on the display color of each of the plurality of cutting points CP on the machining curved surface S. Therefore, it is possible to indicate an interpolated feature even at a portion where the cutting point CP does not exist on the machining curved surface S, which enables the worker to grasp changes in the feature over the entire machining curved surface S, and thus makes it possible to further reduce labor for the analysis work.

In addition, the display device 1A or 1B can further include the curved surface designation unit 111 that designates at least one machining curved surface S included in the machining target shape, and the display unit 30 can be configured to display the cutting point CP present on the machining curved surface S designated among the cutting points CP, and not to display the cutting point CP present on the machining curved surface S that is undesignated. Therefore, by displaying the cutting point CP only for a freely-selected machining curved surface S using an expression method indicating the feature, it is possible to display the feature of only the machining curved surface S that the worker focuses on, and to easily grasp changes in the feature. Thus, the worker's labor for the analysis work can be further reduced.

### Second Embodiment

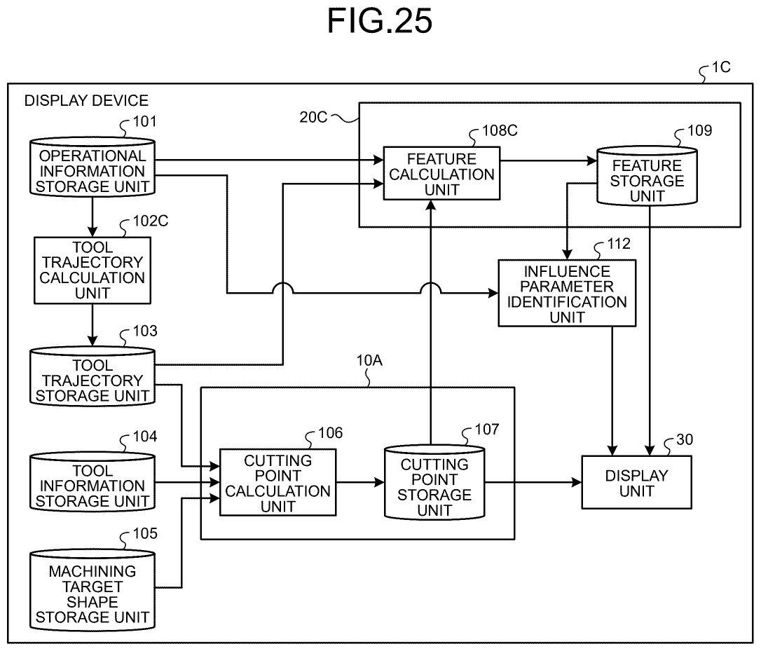

FIG. 25 is a diagram illustrating a functional configuration of a display device 1C according to the second embodiment. The display device 1C includes the operational information storage unit 101, a tool trajectory calculation unit 102C, the tool trajectory storage unit 103, the tool information storage unit 104, the machining target shape storage unit 105, the cutting point information acquisition unit 10A including the cutting point calculation unit 106 and the cutting point storage unit 107, a feature acquisition unit 20C including a feature calculation unit 108C and the feature storage unit 109, the display unit 30, and an influence parameter identification unit 112. Hereinafter, the description of parts similar to those of the display device 1A according to the first embodiment will be omitted, and differences from the display device 1A will be mainly described.

The tool trajectory calculation unit 102C calculates a first tool trajectory by calculating the position of the tip point P based on first position data that is one of two different pieces of position data, and calculates a second tool trajectory by calculating the position of the tip point P based on second position data that is the other piece of position data. The two pieces of position data used here may be different types of position data among a plurality of types of position data indicating the position of the drive shaft of the machine tool 4 and included in one piece of operational information, or may be position data included in two different pieces of operational information for machining the same workpiece W. For example, when time-series data included in the operational information includes a plurality of types of position data such as a command position in every control cycle with respect to the drive shaft of the machine tool 4, a model position, and a detected position detected in every control cycle by the position detector, the first position data and the second position data can be selected from these position data. The tool trajectory calculation unit 102C performs coordinate transformation on the first position data to obtain the position of a first tip point P and the tool direction V at the position. Further, the tool trajectory calculation unit 102C performs coordinate transformation on the second position data to obtain the position of a second tip point P and the tool direction V at the position. Then, the first tip point P and the second tip point P obtained in this manner are associated with each piece of time-series data, and the movement trajectory of the first tip point P is stored as a first tool trajectory and the movement trajectory of the second tip point P is stored as a second tool trajectory in the tool trajectory storage unit 103.

The cutting point calculation unit 106 calculates the position of the cutting point CP for each of the first tool trajectory and the second tool trajectory, and stores cutting point information indicating the calculated position of the cutting point CP in the cutting point storage unit 107.

For each of the plurality of tip points P included in the first tool trajectory and each of the plurality of tip points P included in the second tool trajectory, the feature calculation unit 108C calculates the corresponding features. At this time, the feature calculation unit 108C calculates the same type of feature for the first tool trajectory and the second tool trajectory.

Further, the feature calculation unit 108C obtains the tip point P included in the second tool trajectory corresponding to each of the plurality of tip points P included in the first tool trajectory. Here, as a method of obtaining the tip point P included in the second tool trajectory corresponding to each of the plurality of tip points P included in the first tool trajectory, for example, the feature calculation unit 108C may calculate the distance between the position of the tip point P included in the first tool trajectory and the position of the tip point P included in the second tool trajectory for each combination of tip points P, and set the combination of tip points P having the shortest distance as the corresponding tip point P. Alternatively, based on the position of the cutting point CP with respect to the tip point P included in the first tool trajectory and the position of the cutting point CP with respect to the tip point P included in the second tool trajectory, the feature calculation unit 108C may obtain the corresponding tip point P similarly using the distance between the cutting points CP.

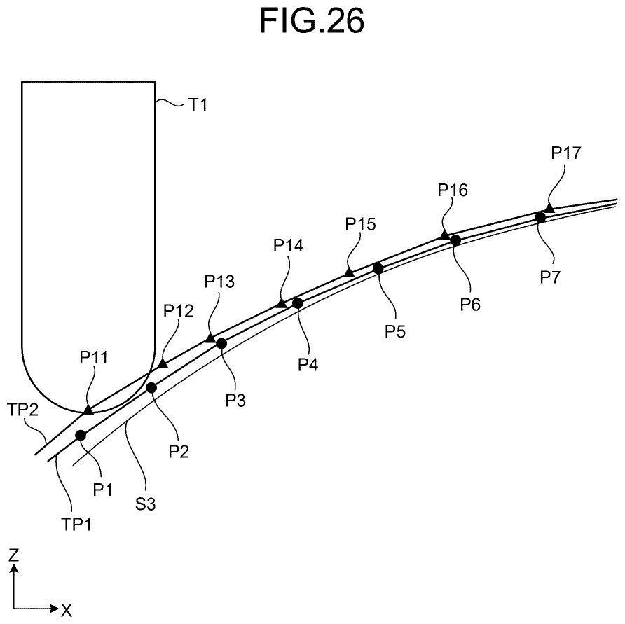

FIG. 26 is a diagram for explaining a method with which the feature calculation unit 108C illustrated in FIG. 25 obtains the corresponding tip point P. Consider a case where the tool trajectory calculation unit 102C has calculated the first tool trajectory TP1 and the second tool trajectory TP2. Suppose that the first tool trajectory TP1 includes tip points P1 to P7 and the second tool trajectory TP2 includes tip points P11 to P17. In this case, the feature calculation unit 108C first obtains the distance between the tip point P1 and each of the tip points P11 to P17. The feature calculation unit 108C can set the tip point P11 at which the distance to the tip point P1 is the smallest as the tip point P corresponding to the tip point P1. For each of the tip points P2 to P7, the corresponding tip point P can be obtained from among the tip points P12 to P17 with a similar method.

Alternatively, the feature calculation unit 108C may associate each of the tip points P1 to P7 included in the first tool trajectory TP1 with the tip points P11 to P17 included in the second tool trajectory TP2 synchronized by time.

Furthermore, the feature calculation unit 108C can obtain the difference value between the features calculated corresponding to the two corresponding tip points P obtained as described above, and use the difference value as a new feature of the tip points P1 to P7 included in the first tool trajectory TP1.

Thus, the feature acquisition unit 20C acquires, as the feature of the first tool trajectory, the difference value between the first feature that is the feature corresponding to each of the plurality of tip points P included in the first tool trajectory and the second feature that is the feature corresponding to each of the tip points P included in the second tool trajectory that is the tool trajectory calculated from the position data of the drive shaft of the machine tool 4 for machining the workpiece W same as the workpiece W of the first tool trajectory, the position data being different from the first tool trajectory.

When the first tool trajectory and the second tool trajectory are generated from different pieces of operational information, the influence parameter identification unit 112 has a function of identifying a parameter of the numerical control device 3 that affects occurrence of the difference value between the feature corresponding to the tip point P of the first tool trajectory and the feature corresponding to the tip point P of the second tool trajectory. At this time, the influence parameter identification unit 112 extracts a difference by comparing the first parameter included in the first operational information with the second parameter included in the second operational information, and identifies a parameter having the difference, thereby identifying a parameter that affects the occurrence of the difference value. Note that, when there is a plurality of parameters having differences, the influence parameter identification unit 112 may simulate the operations of the numerical control device 3 and the machine tool 4 through simulation or the like to narrow down the parameters to the most influential parameter for each of the tip points P at which feature difference values have occurred.

The display unit 30 may identify the cutting point CP corresponding to the tip point P at which a feature difference value has occurred from the tool trajectory, and display the identified cutting point CP using an expression method indicating a parameter that affects the occurrence of the difference value. For example, the display unit 30 uses different colors to display the cutting point CP corresponding to the tip point P at which a feature difference value has occurred mostly due to the parameter A of the numerical control device 3 and the cutting point CP corresponding to the tip point P at which a feature difference value has occurred mostly due to the parameter B of the numerical control device 3.

Note that the division of the functions in the display device 1C illustrated in FIG. 25 is an example, and the method of dividing the functional units is not limited to the example illustrated in FIG. 25 as long as the display device 1C can perform the above-described operation. In FIG. 25, the display device 1C performs all the operations, but a plurality of devices may be used to implement similar functions. For example, in FIG. 25, the display device 1C also has the function of generating information for use in display. However, a device having the display function and a device having the function of calculating the cutting point CP and the feature may be separately provided. Also, the functions of the display device 1C may also be implemented using a cloud system, similarly to the display device 1A. For example, part of the calculation that is performed by the display device 1C can be performed on the cloud system. In the cloud system, it is possible to freely set division of the hardware of the computer system and devices such as a server for each function. For example, one computer system may have a function as a plurality of devices, or a plurality of computer systems may have a function as one device.

As described above, in the display device 1C according to the second embodiment, the feature acquisition unit 20C acquires, as the feature of the first tool trajectory TP1, the difference value between the first feature that is the feature corresponding to each of the plurality of tip points P included in the first tool trajectory TP1 and the second feature that is the feature corresponding to each of the tip points P included in the second tool trajectory TP2 that is the tool trajectory calculated from the position data of the drive shaft of the machine tool 4 for machining the workpiece W same as the workpiece W of the first tool trajectory TP1, the position data being different from the first tool trajectory TP1, Therefore, the cutting point CP can be displayed using an expression method indicating the feature difference value for each piece of position data, which makes it possible to easily grasp at which position data included in the operational information the feature difference has occurred, and thus to reduce the worker's labor for the analysis work of identifying the cause of the machining defect.

In addition, the tool trajectory calculation unit 102C calculates the first tool trajectory TP1 by calculating the position of the tip point P based on first position data that is one of two pieces of position data indicating the position of the drive shaft of the machine tool 4, and calculates the second tool trajectory TP2 by calculating the position of the tip point P based on second position data that is the other piece of position data. The feature calculation unit 108C calculates the feature corresponding to each of the tip point P of the first tool trajectory TP1 and the tip point P of the second tool trajectory TP2, associates each of the plurality of tip points P included in the first tool trajectory TP1 with the tip point P included in the second tool trajectory TP2, calculates a difference value between the two features calculated corresponding to the two tip points P corresponding to each other on the first tool trajectory TP1 and the second tool trajectory TP2, and sets the difference value as the feature of the tip point P of the first tool trajectory TP1. Therefore, the cutting point CP can be displayed using an expression method indicating the feature difference value for each piece of position data, which makes it possible to easily grasp at which position data included in the operational information the feature difference has occurred, and thus to reduce the worker's labor for the analysis work of identifying the cause of the machining defect.

Note that the first position data and the second position data may be different types of position data among a plurality of types of position data included in one piece of operational information, or may be position data included in two different pieces of operational information for machining the same workpiece W.

The machine tool 4 is controlled by the numerical control device 3, and the display device 1C further includes the influence parameter identification unit 112 that identifies, from the operational information, a parameter of the numerical control device 3 that affects occurrence of the feature difference value. Thus, it is possible to grasp which parameter of the numerical control device 3 included in the operational information affects the occurrence of the feature difference value, and thus, it is possible to reduce the worker's labor for the analysis work of identifying the cause of the machining defect.

In addition, the display unit 30 identifies the cutting point CP corresponding to the tip point P at which a feature difference value has occurred based on the tool trajectory, and displays the identified cutting point CP using an expression method indicating a parameter that affects the occurrence of the difference value. Therefore, it is possible to grasp, for each position on the machining target shape M1, which parameter of the numerical control device 3 included in the operational information affects the occurrence of the feature difference value, and thus, it is possible to reduce the worker's labor for the analysis work of identifying the cause of the machining defect.

### Third Embodiment

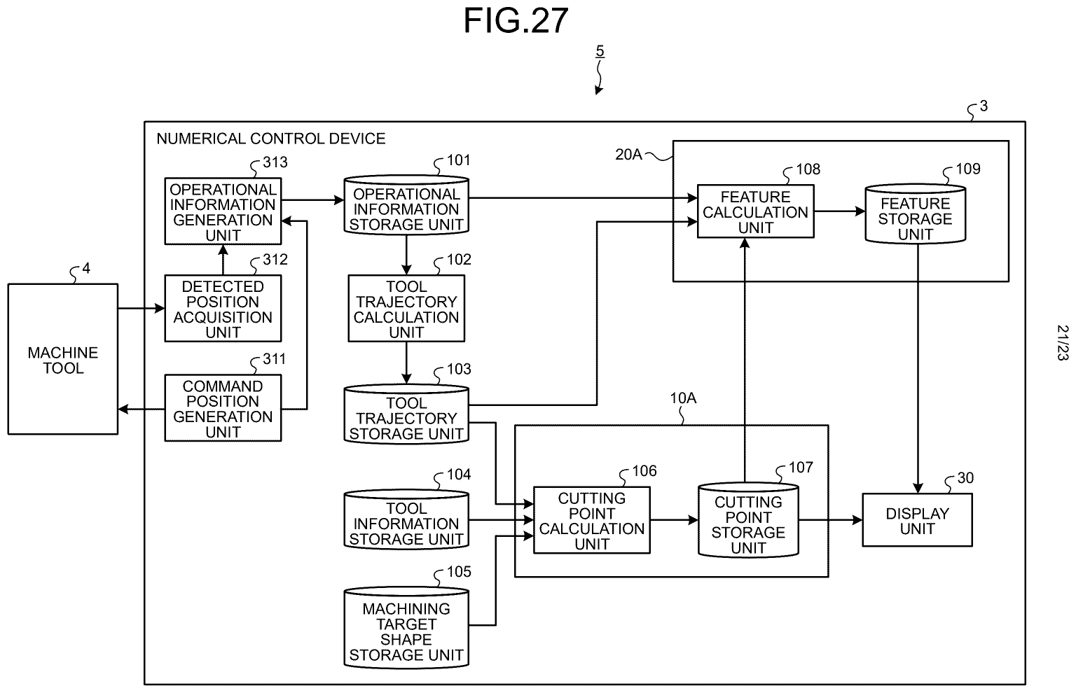

FIG. 27 is a diagram illustrating a functional configuration of the numerical control device 3 according to the third embodiment. The numerical control device 3 includes the operational information storage unit 101, the tool trajectory calculation unit 102, the tool trajectory storage unit 103, the tool information storage unit 104, the machining target shape storage unit 105, the cutting point information acquisition unit 10A including the cutting point calculation unit 106 and the cutting point storage unit 107, the feature acquisition unit 20A including the feature calculation unit 108 and the feature storage unit 109, the display unit 30, a command position generation unit 311, a detected position acquisition unit 312, and an operational information generation unit 313. The numerical control device 3 and the machine tool 4 constitute a machining system 5 that machines the workpiece W by the numerical control device 3 controlling the machine tool 4.

Among the functional units of the numerical control device 3, functional units similar to those of the display device 1A according to the first embodiment are denoted by the same reference signs, and a detailed description thereof will be omitted. Hereinafter, differences from the display device 1A according to the first embodiment will be mainly described.

The numerical control device 3 is connected to the machine tool 4, and controls the machine tool 4 by generating a command position for each drive shaft of the machine tool 4 in every control cycle based on the machining program and numerical control parameters.

Based on the machining program and the numerical control parameters input to the numerical control device 3, the command position generation unit 311 generates a command position for each of the plurality of drive shafts included in the machine tool 4 in every predetermined control cycle, and outputs the generated command position to the machine tool 4. Each of the plurality of drive shafts included in the machine tool 4 is driven by a command position generated in every control cycle. The command position generation unit 311 outputs the generated command position to the operational information generation unit 313.

The detected position acquisition unit 312 acquires a detected position acquired by the position detector provided on each of the plurality of drive shafts included in the machine tool 4. The detected position acquisition unit 312 acquires the detected position in every control cycle, and outputs the acquired detected position to the operational information generation unit 313.

The operational information generation unit 313 generates operational information based on the command position output from the command position generation unit 311 and the detected position output from the detected position acquisition unit 312. Specifically, the operational information generation unit 313 generates operational information as time-series data by synchronizing the command position generated by the command position generation unit 311 at time t with the detected position acquired by the detected position acquisition unit 312 at time t. At this time, a value acquired at time t from a sensor or the like attached to the machine tool 4 simultaneously may be included in the operational information in synchronization with the time-series data. Further, the machining program and the numerical control parameters at this time may be included in the operational information as state data. In addition, the operational information generation unit 313 may generate the operational information during the operation of the machine tool 4, or may temporarily store data obtained from the machine tool 4 which is operating and generate the operational information after the machine tool 4 finishes to operate.

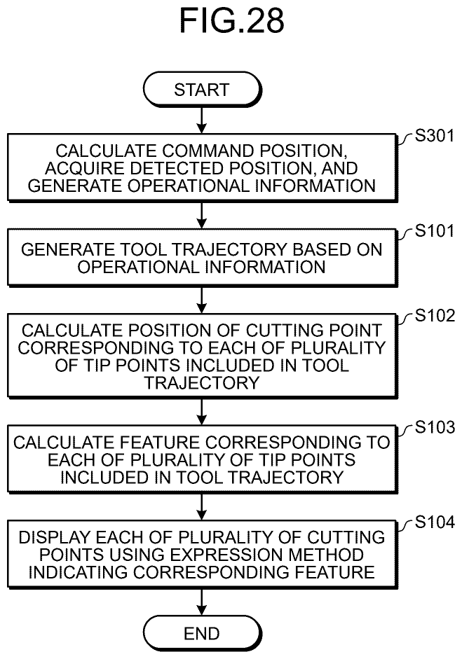

FIG. 28 is a flowchart for explaining the operation of the numerical control device 3 illustrated in FIG. 27. The command position generation unit 311 of the numerical control device 3 calculates a command position, the detected position acquisition unit 312 acquires a detected position, and the operational information generation unit 313 generates operational information using the command position and the detected position (step S301).

Subsequent steps S101 to S104 are similar to the operations in the first embodiment illustrated in FIG. 21, and thus the description thereof is omitted.

Similarly to the display devices 1A to 1C, the numerical control device 3 can execute a display method, and can execute a numerical control method for numerically controlling the machine tool 4 by providing a command position to the machine tool 4 according to the machining program. In addition, the machining system 5 can execute a machining method by the numerical control device 3 controlling the machine tool 4 and by the machine tool 4 machining the workpiece W according to the control.

Next, a hardware configuration of the numerical control device 3 will be described. Each functional unit of the numerical control device 3 is implemented by processing circuitry. The processing circuitry may be implemented by dedicated hardware or a control circuit using a CPU.

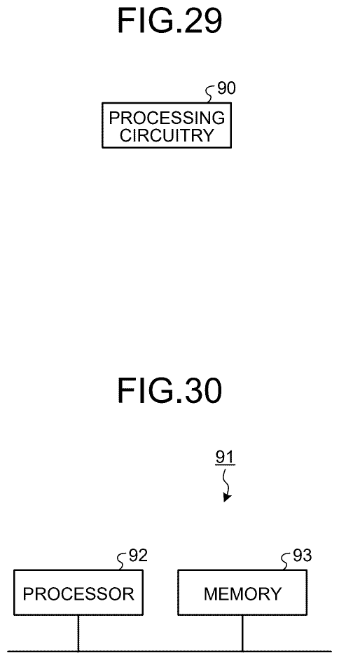

In a case where the above processing circuitry is implemented by dedicated hardware, the processing circuitry is implemented by processing circuitry 90 illustrated in FIG. 29. FIG. 29 is a diagram illustrating dedicated hardware for implementing the functions of the numerical control device 3 according to the third embodiment. The processing circuitry 90 is a single circuit, a composite circuit, a programmed processor, a parallel programmed processor, an application specific integrated circuit (ASIC), a field programmable gate array (FPGA), or a combination thereof.

In a case where the above processing circuitry is implemented by a control circuit using a CPU, this control circuit is, for example, a control circuit 91 having the configuration illustrated in FIG. 30. FIG. 30 is a diagram illustrating a configuration of the control circuit 91 for implementing the functions of the numerical control device 3 according to the third embodiment. As illustrated in FIG. 30, the control circuit 91 includes a processor 92 and a memory 93. The processor 92 is a CPU, and is also called a processing device, an arithmetic device, a microprocessor, a microcomputer, a digital signal processor (DSP), or the like. Examples of the memory 93 include a non-volatile or volatile semiconductor memory, a magnetic disk, a flexible disk, an optical disc, a compact disc, a mini disc, a DVD, and the like. Examples of non-volatile or volatile semiconductor memories include a RAM, a ROM, a flash memory, an erasable programmable ROM (EPROM), an electrically EPROM (EEPROM, registered trademark), and the like.

In a case where the above processing circuitry is implemented by the control circuit 91, the processor 92 reads and executes the program corresponding to the process of each component stored in the memory 93, thereby implementing the processing circuitry. The memory 93 is also used as a temporary memory for each process executed by the processor 92.

As described above, according to the third embodiment, the numerical control device 3 includes: the cutting point information acquisition unit 10A that acquires cutting point information indicating the position of the cutting point CP with respect to the machining target shape M1 of the workpiece W, the cutting point CP being a point at which the tool T1 attached to the machine tool 4 cuts the workpiece W, the cutting point CP corresponding to each of a plurality of tip points P included in the tool trajectory that is information indicating a movement path of the tip point P of the tool T1; the feature acquisition unit 20A that acquires a feature indicating a characteristic of machining, the feature being calculated corresponding to each of the plurality of tip points P based on operational information that is information indicating an operational status of the machine tool 4, the tool trajectory, and the cutting point information; and the display unit 30 that displays each of a plurality of cutting points CP using an expression method indicating the feature corresponding to the cutting point CP based on the cutting point information and the feature. Thus, on the numerical control device 3 that controls the machine tool 4, the cutting point CP is displayed on the machining curved surface S of the machining target shape M1 using an expression method indicating the feature corresponding to the cutting point CP, which makes it easier for the worker who operates the numerical control device 3 to find the correspondence relationship between an actual machining defect on the machining curved surface S and the feature, and makes it possible to reduce labor for the analysis work in which the worker identifies the cause of the machining defect.

The configurations described in the above-mentioned embodiments indicate examples. The embodiments can be combined with another well-known technique and with each other, and some of the configurations can be omitted or changed in a range not departing from the gist.

For example, the curved surface designation unit 111 may be omitted from the configuration of FIG. 1 or 23, or the curved surface designation unit 111 may be added to the configuration of FIG. 25. Alternatively, the curved surface designation unit 111 may be added to the numerical control device 3 illustrated in FIG. 27. In addition, the tool trajectory calculation unit 102C may be provided instead of the tool trajectory calculation unit 102 of the numerical control device 3, the feature acquisition unit 20C may be provided instead of the feature acquisition unit 20A, and the influence parameter identification unit 112 may be further added to the numerical control device 3. In addition, some of the functions of the functional units of the numerical control device 3 illustrated in FIG. 27 may be executed using another information processing device or a cloud system.

In the above embodiments, the display unit 30 displays a plurality of cutting points CP superimposed on the machining target shape M1, but may display only the cutting points CP without displaying the machining target shape M1.

### REFERENCE SIGNS LIST

1A, 1B, 1C display device; 2 Information processing device; 3 numerical control device; 4 machine tool; 5 machining system; 10A, 10B cutting point information acquisition unit; 20A, 20B, 20C feature acquisition unit; 30 display unit; 81 control unit; 82 input unit; 83 storage unit; 84 display unit; 85 communication unit; 86 output unit; 87 system bus; 90 processing circuitry; 91 control circuit; 92 processor; 93 memory; 101 operational information storage unit; 102, 102C tool trajectory calculation unit; 103 tool trajectory storage unit; 104 tool information storage unit; 105 machining target shape storage unit; 106 cutting point calculation unit; 107 cutting point storage unit; 108, 108C feature calculation unit; 109 feature storage unit; 111 curved surface designation unit; 112 influence parameter identification unit; 311 command position generation unit; 312 detected position acquisition unit; 313 operational information generation unit; CP, CP1 to CP7 cutting point; CPS1, CPS1α cutting point group; D8 traveling direction; Lla, Lib, L2a, L2b distance; M1 machining target shape; P, P1 to P17 tip point; PL8 plane; R1, R2 intersection point; S, S1 to S3 machining curved surface; T1 tool; Tlx offset tool; TP1; TP2 tool trajectory; V, V1 to V7 tool direction; W workpiece.

1. A display device comprising:
cutting point information acquisition circuitry to acquire cutting point information indicating a position of a cutting point that is a point at which a tool attached to a machine tool cuts a workpiece, the cutting point corresponding to each of a plurality of tip points included in a tool trajectory that is information indicating a movement path of the tip point of the tool;
feature acquisition circuitry to acquire a feature indicating a characteristic of machining, the feature being calculated corresponding to each of the plurality of tip points based on operational information that is information indicating an operational status of the machine tool, the tool trajectory, and the cutting point information; and
display to display each of a plurality of the cutting points using an expression method indicating the feature corresponding to the cutting point based on the cutting point information and the feature.

2. The display device according to claim 1, wherein the feature acquisition circuitry acquires, as the feature, at least one of machining error amount that is a difference between a machining target shape of the workpiece and the tool, speed of the tip point, acceleration of the tip point, jerk of the tip point, speed of the cutting point, acceleration of the cutting point, jerk of the cutting point, position of a drive shaft of the machine tool, speed of the drive shaft, acceleration of the drive shaft, jerk of the drive shaft, or reverse position of the drive shaft.

3. The display device according to claim 1, wherein the feature acquisition circuitry acquires, as the feature, a difference value of the feature between two adjacent tip points.

4. The display device according to claim 1, wherein
the feature acquisition circuitry acquires a plurality of the features, and
the display displays a first diagram and a second diagram side by side on one screen or superimposed on one screen, the first diagram showing each of the plurality of cutting points using an expression method indicating a first feature that is one of the plurality of features, the second diagram showing each of the plurality of cutting points using an expression method indicating a second feature that is the feature different from the first feature.

5. The display device according to claim 1, wherein the display determines a display color of the cutting point based on the feature corresponding to each of the plurality of cutting points, and determines a display color of a machining curved surface of a machining target shape based on the display color of each of the plurality of cutting points on the machining curved surface.

6. The display device according to claim 1, further comprising
curved surface designation circuitry to designate at least one machining curved surface included in a machining target shape of the workpiece, wherein
the display displays a cutting point present on the machining curved surface designated among the cutting points, and does not display a cutting point present on the machining curved surface that is undesignated.

7. The display device according to claim 1, wherein the feature acquisition circuitry acquires a difference value between a first feature and a second feature as the feature of a first tool trajectory, the first feature being the feature corresponding to each of the plurality of tip points included in the first tool trajectory, the second feature being the feature corresponding to each of the plurality of tip points included in a second tool trajectory that is the tool trajectory calculated from position data of a drive shaft of the machine tool for machining the workpiece same as the first tool trajectory, the position data being different from the first tool trajectory.

8. The display device according to claim 1, further comprising
tool trajectory calculation circuitry to generate the tool trajectory based on operational information that is information indicating an operational status of the machine tool, wherein
the cutting point information acquisition circuitry includes
cutting point calculation circuitry to generate the cutting point information based on the tool trajectory, tool information that is information defining a shape of the tool, and a machining target shape of the workpiece, and
the feature acquisition circuitry includes
feature calculation circuitry to calculate the feature corresponding to each of the tip points based on the operational information, the tool trajectory, and the cutting point information.

9. The display device according to claim 8, wherein
the tool trajectory calculation circuitry calculates a first tool trajectory by calculating a position of the tip point based on first position data that is one of two pieces of position data indicating a position of a drive shaft of the machine tool, and calculates a second tool trajectory by calculating a position of the tip point based on second position data that is an other piece of the position data, and
the feature calculation circuitry
calculates the feature corresponding to each of the tip point of the first tool trajectory and the tip point of the second tool trajectory,
associates each of the plurality of tip points included in the first tool trajectory with the tip point included in the second tool trajectory, and
calculates a difference value between the two features calculated corresponding to the two tip points corresponding to each other on the first tool trajectory and the second tool trajectory, and sets the difference value as the feature of the tip point of the first tool trajectory.

10. The display device according to claim 9, wherein
the operational information includes a plurality of types of position data indicating a position of a drive shaft of the machine tool, and
the first position data and the second position data are different types of position data among a plurality of types of position data included in one piece of the operational information.

11. The display device according to claim 9, wherein the first position data and the second position data are position data included in two different pieces of the operational information for machining the same workpiece.

12. The display device according to claim 9, wherein
the machine tool is controlled by a numerical control device, and
the display device further includes influence parameter identification circuitry to identify, from the operational information, a parameter of the numerical control device that affects occurrence of the difference value.

13. The display device according to claim 12, wherein
the display identifies a cutting point corresponding to the tip point at which the difference value has occurred based on the tool trajectory, and displays the cutting point identified using an expression method indicating the parameter that affects occurrence of the difference value.

14. The display device according to claim 1, wherein the display displays each of the plurality of cutting points superimposed on a machining target shape of the workpiece.

15. A numerical control device comprising:
command position generation circuitry to generate, in every control cycle, a command position for each of a plurality of drive shafts included in a machine tool;
detected position acquisition circuitry to acquire, in every control cycle, a detected position of the drive shafts from a position detector of each of the plurality of drive shafts;
operational information generation circuitry to generate, based on the command position and the detected position, operational information that is information indicating an operational status of the machine tool;
tool trajectory calculation circuitry to generate, based on the operational information, a tool trajectory that is a trajectory of a tip point of a tool attached to the machine tool;
cutting point calculation circuitry to calculate a position, with respect to a machining target shape, of a cutting point corresponding to each of a plurality of the tip points included in the tool trajectory based on the tool trajectory, tool information that is information defining a shape of the tool, and the machining target shape;
feature calculation circuitry to calculate a feature of machining corresponding to each of the tip points based on the operational information, the tool trajectory, and the cutting point; and
display to display each of a plurality of the cutting points using an expression method indicating the feature corresponding to the cutting point.

16. A machining system comprising:
a machine tool; and
the numerical control device according to claim 15 that controls the machine tool.

17. A display method comprising:
acquiring cutting point information indicating a position of a cutting point with respect to a machining target shape of a workpiece, the cutting point being a point at which a tool attached to a machine tool cuts the workpiece, the cutting point corresponding to each of a plurality of tip points included in a tool trajectory that is information indicating a movement path of the tip point of the tool;
acquiring a feature indicating a characteristic of machining, the feature being calculated corresponding to each of the plurality of tip points based on operational information that is information indicating an operational status of the machine tool, the tool trajectory, and the cutting point information; and
displaying each of a plurality of the cutting points using an expression method indicating the feature corresponding to the cutting point based on the cutting point information and the feature.

18. A numerical control method comprising:
numerically controlling a machine tool by generating, in every control cycle, a command position for each of a plurality of drive shafts included in the machine tool based on a machining program and a numerical control parameter, and giving the generated command position to the machine tool;
acquiring cutting point information indicating a position of a cutting point with respect to a machining target shape of a workpiece, the cutting point being a point at which a tool attached to the machine tool cuts the workpiece, the cutting point corresponding to each of a plurality of tip points included in a tool trajectory that is information indicating a movement path of the tip point of the tool;
acquiring a feature indicating a characteristic of machining, the feature being calculated corresponding to each of the plurality of tip points based on operational information that is information indicating an operational status of the machine tool, the tool trajectory, and the cutting point information; and
displaying each of a plurality of the cutting points using an expression method indicating the feature corresponding to the cutting point based on the cutting point information and the feature.

19. A machining method comprising:
numerically controlling a machine tool by generating, in every control cycle, a command position for each of a plurality of drive shafts included in the machine tool based on a machining program and a numerical control parameter, and giving the generated command position to the machine tool;
cutting a workpiece by driving the drive shafts according to the command position given by the numerical control device;
acquiring cutting point information indicating a position of a cutting point with respect to a machining target shape of the workpiece, the cutting point being a point at which a tool attached to the machine tool cuts the workpiece, the cutting point corresponding to each of a plurality of tip points included in a tool trajectory that is information indicating a movement path of the tip point of the tool;
acquiring a feature indicating a characteristic of machining, the feature being calculated corresponding to each of the plurality of tip points based on operational information that is information indicating an operational status of the machine tool, the tool trajectory, and the cutting point information; and
displaying each of a plurality of the cutting points using an expression method indicating the feature corresponding to the cutting point based on the cutting point information and the feature.
